(19) United States
(12) Patent Application Publication
(10) Pub. No.: US 2026/0056589 A1
(43) Pub. Date: Feb. 26, 2026

(54) POWER SUPPLY SYSTEM AND METHOD FOR SUPPLYING POWER IMPLEMENTED BY THE SAME

(71) Applicant: LITE-ON TECHNOLOGY CORP., Taipei (TW)

(72) Inventors: Yi-Hsin FENG, Taipei (TW); Bo-Han LI, Taipei (TW); Ting-Yu HSU, Taipei (TW); Chien-Jung CHIU, Taipei (TW); Ming-Yang TSAI, Taipei (TW)

(21) Appl. No.: 19/081,891

(22) Filed: Mar. 17, 2025

(30) Foreign Application Priority Data
Aug. 22, 2024 (TW) 113131547

(51) Int. Cl. G06F 1/26; G06F 1/3215; G06F 1/3237; H05B 47/185

(52) U.S. Cl. CPC G06F 1/266; G06F 1/3215; G06F 1/3237; H05B 47/187

(57) ABSTRACT

A power supply system includes a power supply device and a controller that is electrically connected to the power supply device. The controller is configured to allow the power supply device to detect whether a power-receiving device is electrically connected to the power supply device. The controller is further configured to, in response to determining that the power supply device is electrically connected to the power-receiving device, start to count a count value. The controller is further configured to, in response to determining that the count value is less than a threshold value, reset the count value, where the count value is for confirming whether the power-receiving device is still being electrically connected to the power supply device.

### CROSS-REFERENCE TO RELATED APPLICATION

This application claims priority to Taiwanese Invention Patent Application No. 113131547, filed on Aug. 22, 2024, the entire disclosure of which is incorporated by reference herein.

### FIELD

The disclosure relates to a technology for supplying power, and more particularly to a power supply system, a method of supplying power, and a non-transitory computer-readable storage medium.

### BACKGROUND

Currently, low-energy technologies have become an important research focus globally. The low-energy technologies allow the performance of electrical devices to be maintained or even improved while reducing power consumption, thereby achieving the purpose of saving energy.

However, when a power supply device of a conventional power supply system is not electrically connected to a power-receiving device, the power supply device is required to periodically, at regular intervals of time, detect whether a connection to the power-receiving device is established, which increases power consumption in a no-load condition, thereby failing to conserve energy.

Additionally, when the power supply device detects a power-receiving device connected thereto and begins to provide power to the power-receiving device, if the power-receiving device is suddenly disconnected but then quickly reconnected within a short time, the power supply device will still immediately stop providing power when the disconnection occurs. The power supply device will then resume providing power to the power-receiving device after detecting that the power-receiving device is connected thereto in a next interval of time. In such a case, a period between a time point, from which the power supply device stops providing power, and a time point, from which the power supply device resumes providing power, can be long, meaning that the power supply device is unable to immediately resume power provision to the power-receiving device even if the power-receiving device is quickly reconnected.

### SUMMARY

Therefore, an object of the disclosure is to provide a power supply system, a method of supplying power, and a non-transitory computer-readable storage medium that can alleviate at least one of the drawbacks of the prior art.

According to the disclosure, a power supply system includes a power supply device and a controller that is electrically connected to the power supply device. The controller is configured to allow the power supply device to detect whether a power-receiving device is electrically connected to the power supply device. The controller is further configured to, in response to determining that the power supply device is electrically connected to the power-receiving device, start to count a count value. The controller is further configured to, in response to determining that the count value is less than a threshold value, reset the count value, where the count value is for confirming whether the power-receiving device is still being electrically connected to the power supply device.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a power supply system according to an embodiment of the disclosure.

FIG. 2 is a flow chart illustrating a method for supplying power according to a first embodiment of the disclosure.

FIG. 3 is a part of a flow chart of the method for supplying power according to a second embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

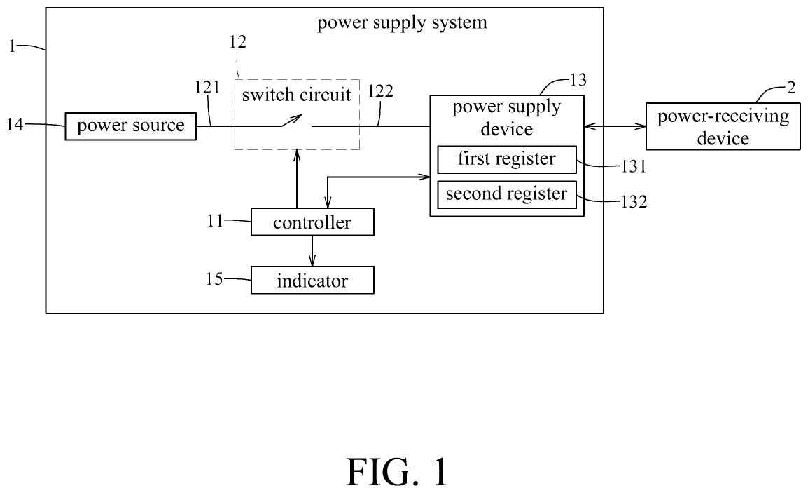

Referring to FIG. 1, a power supply system 1 according to an embodiment of the disclosure includes a controller 11, a switch circuit 12, and a power supply device 13. The controller 11 is electrically connected to the power supply device 13 and the switch circuit 12, allowing the power supply device 13 to detect whether a power-receiving device 2 is electrically connected to the power supply device 13 (i.e., whether a connection to the power-receiving device 2 is established). The switch circuit 12 includes a first end 121 that is electrically connected to a power source 14, and a second end 122 that is electrically connected to the power supply device 13. The switch circuit 12 is configured to be controlled by the controller 11. The power-receiving device 2 is configured to be electrically connected to the power supply device 13, and the controller 11 controls the power supply device 13 to provide power to the power-receiving device 2 when the connection is established. For example, the power source 14 is a power supply unit (PSU) of the power supply system 1.

In this embodiment, the power supply system 1 may be a Power over Ethernet (PoE) system, the controller 11 may be a microcontroller unit (MCU), the power supply device 13 may be a power sourcing equipment (PSE) in the PoE system, and the power-receiving device 2 may be a powered device (PD).

It should be noted that, in a conventional PoE system, a PSE includes a control chip that is configured to communicate with a PD and to detect whether the PD is electrically connected to the conventional PoE system (i.e., whether the PD is electrically connected to the PSE), so as to control the PSE to provide power to the PD. Therefore, when there is no PD electrically connected to the PSE, the control chip of the PSE in the conventional PoE system is required to keep operating so as to continuously detect whether there is a PD electrically connected to the PSE, which increases power consumption in a no-load condition (i.e., when not connected to a PD). According to the Department of Energy Level VII (DoE VII) specification, any PSE with a power output of less than 49 W is required to have power consumption of less than 75 mW during the no-load condition. However, since the control chip of the PSE of the conventional PoE system is required to keep operating during the no-load condition, the conventional PoE system is generally unable to comply with the DoE VII specification. The power supply system 1 provided in the disclosure is able to comply with the DoE VII specification, and is described in the following.

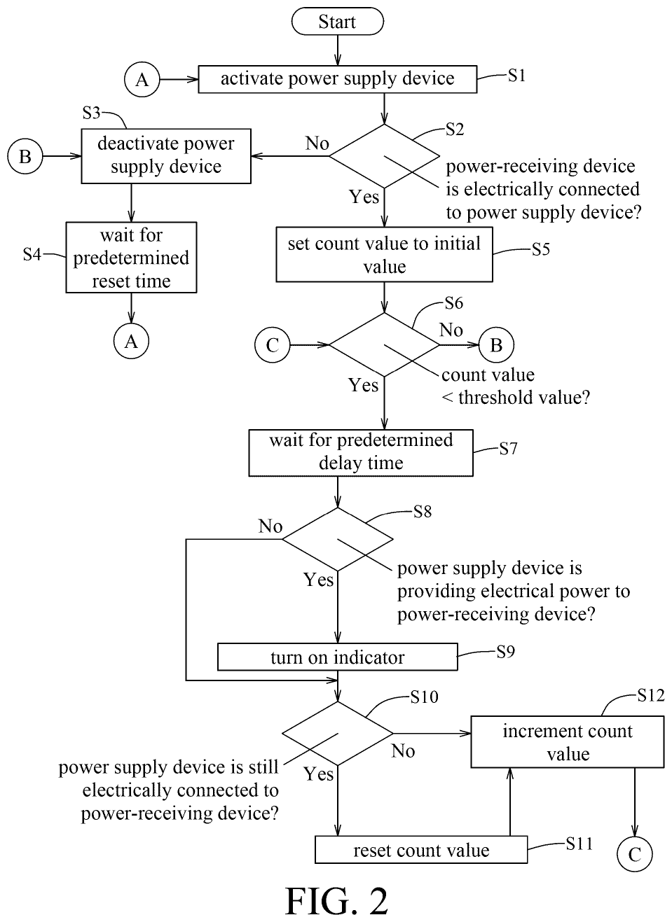

Referring further to FIG. 2, which is a flow chart of a method for supplying power according to a first embodiment of the disclosure, the method includes steps S1 to S12, and is described in the following in conjunction with FIG. 1.

In step S1, the controller 11 activates the power supply device 13. In this embodiment, when the controller 11 wants to activate the power supply device 13, the controller 11 controls the switch circuit 12 to enable an electrical connection between the power source 14 and the power supply device 13, so that the power source 14 is able to provide power to the power supply device 13 through the switch circuit 12, thereby activating the power supply device 13.

In step S2, the controller 11 allows the power supply device 13 to detect whether the power-receiving device 2 is electrically connected to the power supply device 13. If the power supply device 13 is not electrically connected to the power-receiving device 2, a flow of the method proceeds to step S3; otherwise, the flow proceeds to step S5.

Specifically, the power supply device 13 includes a first register 131 that is used to indicate whether the power-receiving device 2 is electrically connected to the power supply device 13. In step S2, the power supply device 13 detects whether the power-receiving device 2 is electrically connected thereto, and the power supply device 13 stores a first value, which represents the connection status between the power supply device 13 and the power-receiving device 2, in the first register 131. The controller 11 may then read the first value stored in the first register 131 to determine whether the power-receiving device 2 is electrically connected to the power supply device 13. In one embodiment, the first value is represented by a hexadecimal value.

In an embodiment, when the controller 11 determines, in step S2, that the power-receiving device 2 is not electrically connected to the power supply device 13, the flow proceeds to step S3, where the controller 11 deactivates the power supply device 13. Then, in step S4, the controller 11 waits for a predetermined reset time (e.g., “M” seconds, where “M”is a value greater than one), and then repeats (goes back to) step S1.

To describe in further detail, when the controller 11 wants to deactivate the power supply device 13, the controller 11 controls the switch circuit 12 to disable the electrical connection between the power source 14 and the power supply device 13, so that the power source 14 is unable to provide power to the power supply device 13 through the switch circuit 12, thereby deactivating the power supply device 13. It should be noted that a length of the predetermined reset time may be set according to user preference, depending on how much power is desired to be saved. Specifically, the longer the length of the predetermined reset time is, the more power is saved. In one example, the predetermined reset time may be set such that the power supply system 1 complies with the DoE VII specification (i.e., any PSE with a power output of less than 49 W is required to have power consumption of less than 0.075 W during the no-load condition). Thus, in the absence of an electrical connection between the power supply system 1 and the power-receiving device 2 (load), this embodiment may effectively reduce the power consumption of the power supply system 1.

In another embodiment, when the controller 11 determines, in step S2, that the power-receiving device 2 is electrically connected to the power supply device 13, the flow proceeds to step S5, where the controller 11 sets a count value of a counter (not shown) included in the controller 11 to an initial value, and the flow proceeds to step S6. In one embodiment, the initial value is equal to one. In some embodiments, the initial value may be zero or other values, but the disclosure is not limited to such.

In step S6, the controller 11 determines whether the count value of the counter is greater than or equal to a threshold value, where the threshold value is an integer that is greater than one. If the count value is greater than or equal to the threshold value, the flow goes back to step S3, where the controller 11 deactivates the power supply device 13. Subsequently, the controller 11 implements step S4 to wait for the predetermined reset time, and then repeats step S1. Otherwise, if the count value is less than the threshold value, the flow proceeds to step S7. In step S7, the controller 11 waits for a predetermined delay time, and then the flow proceeds to step S8. In one embodiment, a product of the threshold value and the predetermined delay time is less than or equal to 30 seconds, so as to comply with a standard established by Sifos Technologies, Inc. for obtaining a certificate for a PSE test analysis, where the standard requires rapid power supply within 30 seconds. In one example, the threshold value is equal to 21, and the predetermined delay time is equal to 1.25 seconds, but the disclosure is not limited to such.

The power supply system 1 further includes an indicator 15 that is electrically connected to the controller 11, and that is configured to indicate whether the power supply device 13 is providing electrical power to the power-receiving device 2. The power supply device 13 also includes a second register 132, which is used to indicate whether the power supply device 13 is providing electrical power to the power-receiving device 2. Specifically, the power supply device 13 stores a second value, which represents whether the power supply device 13 is providing electrical power to the power receiving device 2, in the second register 132. The controller 11 may then read the second value in the second register 132 to confirm whether the power supply device 13 is providing electrical power to the power-receiving device 2. In one embodiment, the indicator 15 may be a light-emitting diode (LED), and the second value may be represented by a hexadecimal value.

In step S8, the controller 11 reads the value of the second value stored in the second register 132 to determine and confirm whether the power supply device 13 is providing electrical power to the power-receiving device 2. If the determination is affirmative, the flow proceeds to step S9, where the controller 11 turns on the indicator 15 (e.g., lights up the LED), and the flow proceeds to step S10; otherwise, the controller 11 turns off (or does not turn on) the indicator 15 (e.g., does not light up the LED), and the flow proceeds to step S10 (i.e., the controller 11 directly proceeds to step S10 without implementing step S9). In some embodiments, steps S8 and S9 may be omitted. In some embodiments, if the threshold value is set to be very high such that the product of the threshold value and the predetermined delay time is close to 30 seconds when the count value equals the threshold value, step S7 may also be omitted.

In step S10, the power supply device 13 detects whether the power-receiving device 2 is still being electrically connected to the power supply device 13, so that the controller 11 may determine whether the power-receiving device 2 is electrically connected to the power supply device 13 in the same manner as step S2. If the determination is affirmative, the flow proceeds to step S11.

In step S11, the controller 11 resets the count value of the counter (e.g., to zero), and the flow proceeds to step S12. In step S12, the controller 11 increases the count value by a predetermined value (e.g., by one) (i.e., the controller 11 increments the count value), so that the count value is equal to the initial value (e.g., is equal to one), and the flow goes back to step S6, where the controller 11 may confirm whether the power-receiving device 2 is still being electrically connected to the power supply device 13 based on the count value.

In step S10, if the determination is negative, the flow directly proceeds to step S12, where the controller 11 increases the count value by the predetermined value, and the flow goes back to step S6.

In one example, the initial value of the count value is equal to one, and when the controller 11 determines that the power supply device 13 is still electrically connected to the power-receiving device 2 (step S10), the controller 11 resets the count value to be equal to zero (step S11), and then increases the count value by one (step S12), so that the count value is equal to one, which is the initial value. As such, the controller 11 may confirm, in step S6, that the power supply device 13 is still electrically connected to the power-receiving device 2 based on the count value (which is less than the threshold value). In another example, when the controller 11 determines that the power supply device 13 is not electrically connected to the power-receiving device 2 (step S10), the controller 11 increases the count value (e.g., 20) by one (step S12), and then when the controller 11 determines that the count value (e.g., 21) is not less than the threshold value (e.g., 21) (step S6), the controller 11 may confirm that the power supply device 13 is not electrically connected to the power-receiving device 2.

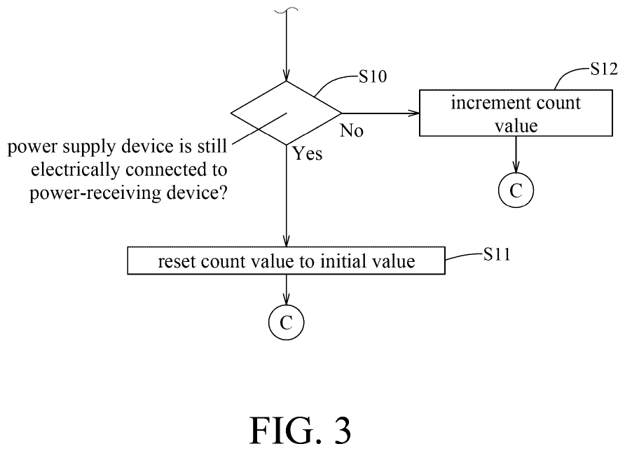

Referring further to FIG. 3, a second embodiment of the method is similar to the first embodiment (FIG. 2), and their difference resides in step S11. Specifically, in the second embodiment, when the controller 11 determines that the power supply device 13 is still electrically connected to the power-receiving device 2 in step S10, the flow proceeds to step S11, where the controller 11 resets the count value to be equal to the initial value, and the flow goes back to step S6, rather than proceeding to step S12. Otherwise, when the controller 11 determines that the power supply device 13 is not electrically connected to the power-receiving device 2 in step S10, the flow proceeds to step S12, where the controller 11 increases the count value by the predetermined value (e.g., by one), and the flow goes back to step S6.

The difference between the first embodiment and the second embodiment is summarized below. In the second embodiment, step S11 directly resets the count value to be equal to the initial value, and then the flow goes back to step S6; whereas in the first embodiment, step S11 resets the count value to be equal to the initial value minus the predetermined value, and then step S12 increases the count value by the predetermined value so that the count value is equal to the initial value.

As such, if the power-receiving device 2 is suddenly disconnected from the power supply device 13, immediately after step S6, the controller 11 would determine that the count value of the counter has not reached the threshold value (i.e., a duration of the power-receiving device 2 being disconnected from the power supply device 13 has not reached 30 seconds), and if the power-receiving device 2 is reconnected to the power supply device 13 before the count value reaches the threshold value, the power supply device 13 would not be deactivated (i.e., would not be disconnected from the power source 14). In such a case, the power supply device 13 may immediately provide power to the power-receiving device 2 that has been temporarily disconnected and quickly reconnected, and thus the power supply system 1 complies with the requirement of rapid power supply within 30 seconds that is established by Sifos Technologies, Inc.

Additionally, according to an embodiment of the disclosure, a non-transitory computer-readable storage medium is to be executed by a computing device that includes a processor (e.g., a central processing unit (CPU) or a graphics processing unit (GPU)) and/or a computer memory (e.g., hard disk drives, random access memory (RAM), read only memory (ROM), programmable ROM (PROM) or flash memory), and the non-transitory computer-readable storage medium stores a plurality of instructions. The instructions may be executed by the processor and/or the computer memory of the computing device, which would cause the computing device to perform the method in the first embodiment or the second embodiment. In one example, the non-transitory computer-readable storage medium is a non-volatile memory.

In summary, according to the disclosure, the controller 11 activates the power supply device 13 to detect whether the power-receiving device 2 is electrically connected to the power supply device 13, and when the controller 11 determines that the power-receiving device 2 is not electrically connected to the power supply device 13 (i.e., the count value reaches the threshold value), the controller 11 deactivates the power supply device 13, waits for the predetermined reset time, and then repeats the steps above. As such, the power supply device 13 is not required to continuously detect whether the power-receiving device 2 is electrically connected to the power supply device 13, thereby reducing power consumption.

Moreover, when the power supply device 13 detects that the power-receiving device 2 is electrically connected to the power supply device 13, the power supply device 13 repeatedly detects whether the power-receiving device 2 is still electrically connected to the power supply device 13, and such detection continues until the controller 11 determines that the power-receiving device 2 has been disconnected from the power supply device 13 for a predetermined time period (i.e., the product of the threshold value and the predetermined delay time). The controller 11 would then deactivate the power supply device 13, wait for the predetermined reset time, and then repeat the steps above. As such, the power supply device 13 may immediately provide power to the power-receiving device 2 if the power-receiving device 2 is only temporarily disconnected and quickly reconnected to the power supply device 13.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A power supply system, comprising:
a power supply device; and
a controller electrically connected to said power supply device, and configured to
allow said power supply device to detect whether a power-receiving device is electrically connected to said power supply device,
in response to determining that said power supply device is electrically connected to the power-receiving device, start to count a count value, and
in response to determining that the count value is less than a threshold value, reset the count value, where the count value is for confirming whether the power-receiving device is still being electrically connected to said power supply device.

2. The power supply system as claimed in claim 1, wherein said controller is further configured to, in response to determining that the count value is less than the threshold value, wait for a predetermined delay time, and then determine whether said power supply device is still being electrically connected to the power-receiving device.

3. The power supply system as claimed in claim 1, wherein said controller is further configured to, after determining that said power supply device is electrically connected to the power-receiving device, continuously determine whether said power supply device is still being electrically connected to the power-receiving device, and in response to determining that said power supply device is not electrically connected to the power-receiving device, increment the count value, and
wherein, in response to determining that the count value is not less than the threshold value, said controller determines that the power-receiving device is not electrically connected to said power supply device.

4. The power supply system as claimed in claim 3, wherein said controller is further configured to, in response to the condition where the power-receiving device is not electrically connected to said power supply device, wait for a predetermined reset time, and then allow said power supply device to detect again whether the power-receiving device is electrically connected to said power supply device.

5. The power supply system as claimed in claim 3, further comprising an indicator that is electrically connected to said controller, wherein said controller is further configured to control operation of said indicator based on whether said power supply device is providing electrical power to the power-receiving device.

6. The power supply system as claimed in claim 5, wherein said controller is configured to, in response to determining that said power supply device is providing electrical power to the power-receiving device, turn on said indicator.

7. The power supply system as claimed in claim 3, wherein said power supply device includes a first register and a second register,
wherein said power supply device is configured to detect a result of whether the power-receiving device is electrically connected to said power supply device, and to store a first parameter in said first register indicating the result, and
wherein said power supply device is further configured to detect another result of whether said power supply device is providing electrical power to the power-receiving device, and to store a second parameter in said second register indicating said another result.

8. The power supply system as claimed in claim 1, further comprising a switch circuit that is electrically connected to said controller and that includes a first end electrically connected to a power source, and a second end electrically connected to said power supply device,
wherein said controller is further configured to control said switch circuit to enable an electrical connection between said power source and said power supply device so as to activate said power supply device, and to control said switch circuit to disable the electrical connection between said power source and said power supply device so as to deactivate said power supply device.

9. A method for supplying power to be implemented by a power supply system, the power supply system including a power supply device and a controller that is electrically connected to the power supply device, the method comprising, by the controller:
allowing the power supply device to detect whether a power-receiving device is electrically connected to the power supply device;
in response to determining that the power supply device is electrically connected to the power-receiving device, starting to count a count value; and
in response to determining that the count value is less than a threshold value, resetting the count value, where the count value is for confirming whether the power-receiving device is still being electrically connected to the power supply device.

10. The method as claimed in claim 9, further comprising, by the controller, in response to determining that the count value is less than the threshold value, waiting for a predetermined delay time, and then determining whether the power supply device is still being electrically connected to the power-receiving device.

11. The method as claimed in claim 9, further comprising, by the controller:
after determining that the power supply device is electrically connected to the power-receiving device, continuously determining whether the power supply device is still being electrically connected to the power-receiving device, and
in response to determining that the power supply device is not electrically connected to the power-receiving device, incrementing the count value,
wherein, in response to determining that the count value is not less than the threshold value, the controller determining that the power-receiving device is not electrically connected to the power supply device.

12. The method as claimed in claim 11, further comprising, by the controller, in response to the condition where the power-receiving device is not electrically connected to the power supply device, waiting for a predetermined reset time, and then allowing the power supply device to detect again whether the power-receiving device is electrically connected to the power supply device.

13. The method as claimed in claim 11, the power supply system further including an indicator that is electrically connected to the controller, the method further comprising, by the controller, controlling operation of the indicator based on whether the power supply device is providing electrical power to the power-receiving device.

14. The method as claimed in claim 13, wherein the controller controlling operation of the indicator includes, in response to determining that the power supply device is providing electrical power to the power-receiving device, the controller turning on the indicator.

15. The method as claimed in claim 11, the power supply device including a first register and a second register, the method further comprising, by the power supply device:
detecting a result of whether the power-receiving device is electrically connected to the power supply device, and storing a first parameter in the first register indicating the result, and
detecting another result of whether the power supply device is providing electrical power to the power-receiving device, and storing a second parameter in the second register indicating said another result.

16. The method as claimed in claim 9, the power supply system further including a switch circuit that is electrically connected to the controller, the method further comprising, by the controller:
controlling the switch circuit to enable an electrical connection between a power source and the power supply device so as to activate the power supply device; and
controlling the switch circuit to disable the electrical connection between the power source and the power supply device so as to deactivate the power supply device.

17. A non-transitory computer-readable storage medium storing a plurality of instructions that, when executed by a computing device, cause the computing device to perform the method as claimed in claim 9.
